(19) United States
(12) Patent Application Publication
(10) Pub. No.: US 2017/0154286 A1
(43) Pub. Date: Jun. 1, 2017

(54) METHODS AND SYSTEMS FOR IDENTIFYING RISKS AND ASSOCIATED ROOT CAUSES IN SUPPLY CHAIN NETWORKS

(71) Applicant: Wipro Limited, Bangalore (IN)

(72) Inventor: Selvakuberan Karuppasamy, Chennai (IN)

(21) Appl. No.: 14/993,846

(22) Filed: Jan. 12, 2016

(30) Foreign Application Priority Data
Nov. 27, 2015 (IN) 6387/CHE/2015

(51) Int. Cl. G06Q 10/06

(52) U.S. Cl. CPC G06Q 10/0635

(57) ABSTRACT

This disclosure relates generally to supply chain networks and more particularly to methods and systems for identifying risks and associated root causes in supply chain networks. In one embodiment, the method includes receiving, via a risk analyzing device, a user query; performing, via the risk analyzing device, natural language processing and text analysis on the user query to derive contextually relevant keywords from the user query; categorizing, via the risk analyzing device, the contextually relevant keywords into a risk category selected from a plurality of risk categories; identifying, via the risk analyzing device, a risk in the supply chain network based on the contextually relevant keywords and the risk category; and detecting, via the risk analyzing device, a root cause from amongst a plurality of root causes associated with the risk using a causal analysis.

This application claims the benefit of Indian Patent Application Serial No. 6387/CHE/2015 filed Nov. 27, 2015, which is hereby incorporated by reference in its entirety.

### FIELD

This disclosure relates generally to supply chain networks and more particularly to methods and systems for identifying risks and associated root causes in supply chain networks.

### BACKGROUND

Supply chain network is a network of actions followed or practiced to achieve a common goal. The main objective of the supply chain is customer satisfaction. However, when the supply chain network does not work properly or meets the desired objectives, customer satisfaction would suffer. As a result, entire supply chain network will incur huge losses. The challenge is such scenario is to analyze the loss of the supply chain network in order to identify the risk or disruption in the supply chain network.

The process of risk identification in some conventional systems is very time consuming and thus results in customer dissatisfaction or in a worst case scenario causes the customer to leave the supply chain network altogether.

### SUMMARY

In one embodiment, a method of identifying root causes in a supply chain network is disclosed. The method includes receiving, via a risk analyzing device, a user query; performing, via the risk analyzing device, natural language processing and text analysis on the user query to derive contextually relevant keywords from the user query; categorizing, via the risk analyzing device, the contextually relevant keywords into a risk category selected from a plurality of risk categories; identifying, via the risk analyzing device, a risk in the supply chain network based on the contextually relevant keywords and the risk category; and detecting, via the risk analyzing device, a root cause from amongst a plurality of root causes associated with the risk using a causal analysis algorithm.

In another embodiment, a system for identifying root causes in a supply chain network is disclosed. The system includes at least one processors and a computer-readable medium. The computer-readable medium stores instructions that, when executed by the at least one processor, cause the at least one processor to perform operations that include receiving, via a risk analyzing device, a user query; performing, via the risk analyzing device, natural language processing and text analysis on the user query to derive contextually relevant keywords from the user query; categorizing, via the risk analyzing device, the contextually relevant keywords into a risk category selected from a plurality of risk categories; identifying, via the risk analyzing device, a risk in the supply chain network based on the contextually relevant keywords and the risk category; and detecting, via the risk analyzing device, a root cause from amongst a plurality of root causes associated with the risk using a causal analysis algorithm.

In yet another embodiment, a non-transitory computer-readable storage medium for rationalizing a portfolio of assets is disclosed, which when executed by a computing device, cause the computing device to: receive, via a risk analyzing device, a user query; perform, via the risk analyzing device, natural language processing and text analysis on the user query to derive contextually relevant keywords from the user query; categorize, via the risk analyzing device, the contextually relevant keywords into a risk category selected from a plurality of risk categories; identify, via the risk analyzing device, a risk in the supply chain network based on the contextually relevant keywords and the risk category; and detect, via the risk analyzing device, a root cause from amongst a plurality of root causes associated with the risk using a causal analysis algorithm.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary computer system for implementing various embodiments.

FIG. 2 is a block diagram illustrating a risk analyzing device for identifying a root cause in a supply chain network, in accordance with an embodiment.

FIG. 3 illustrates a flowchart of a method of identifying root causes in a supply chain network, in accordance with an embodiment.

FIG. 4 illustrates a flowchart of a method of identifying root causes in a supply chain network, in accordance with another embodiment.

FIG. 5 illustrates risk components and associated root causes in a product manufacturing supply chain network, in accordance with an exemplary embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

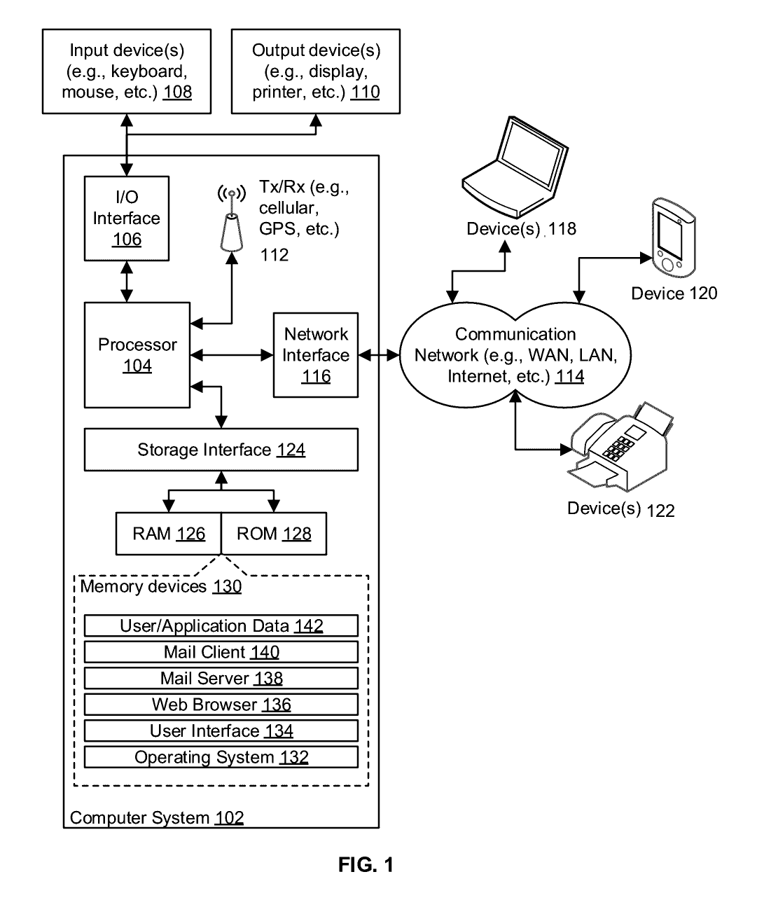

Additional illustrative embodiments are listed below. In one embodiment, a block diagram of an exemplary computer system for implementing various embodiments is disclosed in FIG. 1. Computer system 102 may comprise a central processing unit (“CPU” or “processor”) 104. Processor 104 may comprise at least one data processor for executing program components for executing user-or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. Processor 104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 104 may be disposed in communication with one or more input/output (I/O) devices via an I/O interface 106. I/O interface 106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 106, computer system 102 may communicate with one or more I/O devices. For example, an input device 108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 110 may be a printer, fax machine, video display (e.g., cathode ray tube (CRT), liquid crystal display (LCD), light-emitting diode (LED), plasma, or the like), audio speaker, etc. In some embodiments, a transceiver 112 may be disposed in connection with processor 104. Transceiver 112 may facilitate various types of wireless transmission or reception. For example, transceiver 112 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 104 may be disposed in communication with a communication network 114 via a network interface 116. Network interface 116 may communicate with communication network 114. Network interface 116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 114 may include, without limitation, a direct interconnection, local area network (LAN), wide area network (WAN), wireless network (e.g., using Wireless Application Protocol), the Internet, etc. Using network interface 116 and communication network 114, computer system 102 may communicate with devices 118, 120, and 122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 102 may itself embody one or more of these devices.

In some embodiments, processor 104 may be disposed in communication with one or more memory devices (e.g., RAM 126, ROM 128, etc.) via a storage interface 124. Storage interface 124 may connect to memory devices 130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 130 may store a collection of program or database components, including, without limitation, an operating system 132, a user interface application 134, a web browser 136, a mail server 138, a mail client 140, a user/application data 142 (e.g., any data variables or data records discussed in this disclosure), etc. Operating system 132 may facilitate resource management and operation of the computer system 102. Examples of operating system 132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 134 may facilitate display, execution, interaction, manipulation, or operation of program components through textual or graphical facilities. For example, user interfaces may provide computer interaction interface elements on a display system operatively connected to computer system 102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 102 may implement web browser 136 stored program components. Web browser 136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 102 may implement mail server 138 stored program component. Mail server 138 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 102 may implement mail client 140 stored program component. Mail client 140 may be a mail viewing application, such as Apple Mail, Microsoft Entourage, Microsoft Outlook, Mozilla Thunderbird, etc.

In some embodiments, computer system 102 may store user/application data 142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the technology with reference to different functional units and processors. However, it will be apparent that any suitable distribution of functionality between different functional units, processors or domains may be used without detracting from the technology. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

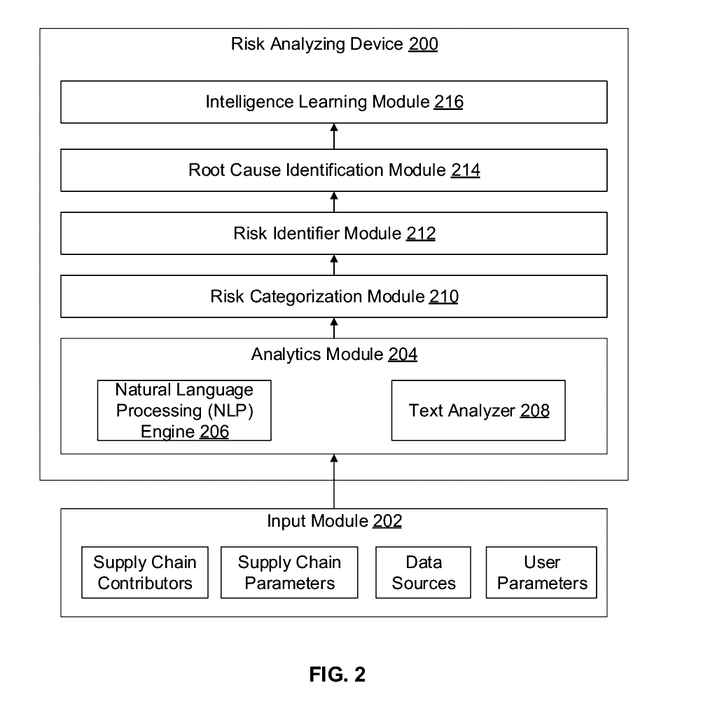

FIG. 2 is a block diagram illustrating a risk analyzing device 200 for identifying a root cause in a supply chain network, in accordance with an embodiment. Risk analyzing device 200 communicates with an input module 202 to receive a plurality of supply chain inputs associated with the supply chain network. The plurality of supply chain inputs may include, but are not limited to supply chain contributors, supply chain parameters, and supply chain data sources. The supply chain contributors may include, but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters.

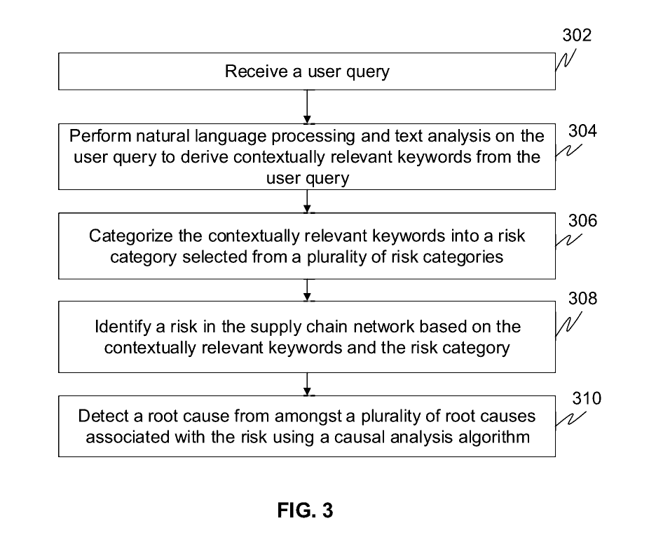

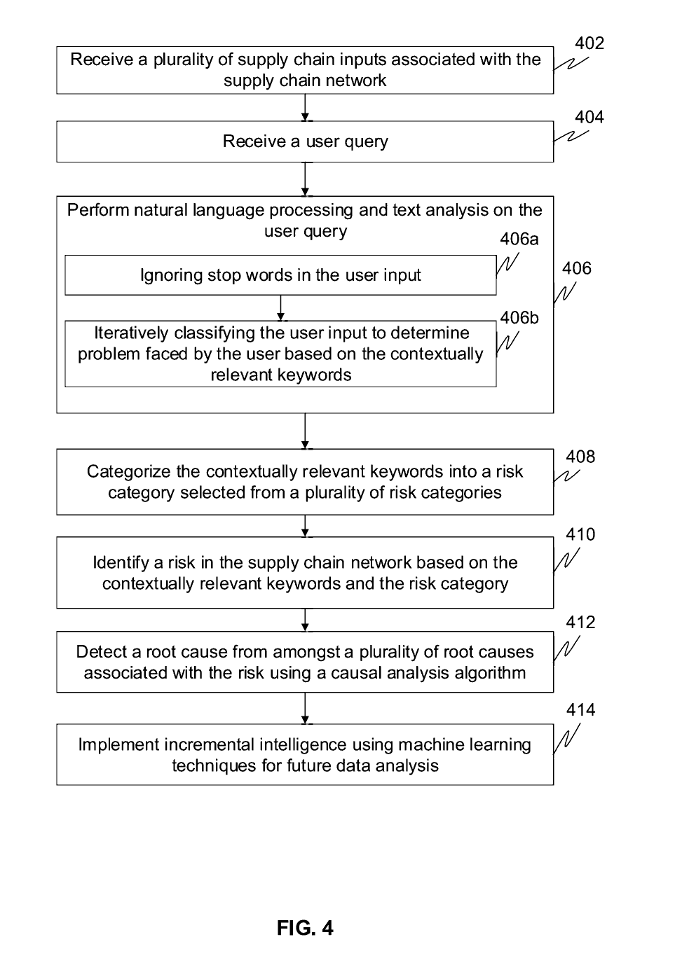

In addition to receiving the plurality of supply chain parameters, risk analyzing device 200 recieves user query as user parameters. Thereafter, an analytics module 204 analyses the user query using an Natural Language Processing (NLP) engine 206 and a text analyzer 208 to derive contextually relevant keywords from the user query. A risk categorizing module 210 categorizes the contextually relevant keywords into a risk category selected from a plurality of risk categories. Based on the contextually relevant keywords and the risk category, a risk identifier module 212 identifies a risk in the supply chain network. A root cause identification module 214 detects a root cause from amongst a plurality of root causes associated with the risk using a causal analysis algorithm. This is further explained in detail in conjucntion with FIG. 3. An intelligence learning module 216 implements incremental intelligence using machine learning techniques for future data analysis. This is further explained in detail in conjucntion with FIG. 4.

FIG. 3 illustrates a flowchart of a method of identifying root causes in a supply chain network, in accordance with an embodiment. To initialize the system in the supply chain network, a plurality of supply chain inputs associated with the supply chain network are received. The plurality of supply chain inputs may include, but are not limited to supply chain contributors, supply chain parameters, and supply chain data sources, the supply chain data sources being selected based on the supply chain parameters. This is further explained in detail in conjunction with FIG. 4.

At 302, a risk analyzing device receives a user query. The user query denotes the exact problem description that the user is facing. The user query may include, but is not limited to one or more of an audio query and a text query. The user, for example, may log a ticket with the supply chain network. The ticket may read as: “I didn't get my Camera delivered still. The product ordered two weeks before.” The ticket may have been logged either verbally through a user utterance on an audio call or may have been inputted in the form of text from a user device. Examples of the user devices may include but are not limited to a computer, a laptop, a mobile device, a tablet, and a phablet.

At 304, the risk analyzing device performs natural language processing and text analysis on the user query. Natural language processing is used mostly to analyze user utterances. Natural language processing may also be applied to speech and text. In an embodiment, when it pertains to email prioritization, natural language processing may include sentence detection, tokenization, sentence tagging, parts of speech tagging, named entity recognition, and co-reference resolution. The natural language processing is used to scan the user query to recognize the necessary nouns, pronouns, and named entities in order to identify the exact problem description that the user is facing. Further, the text analysis is performed to scan content of the user utterance or text written by the user. Text analysis includes performing iterative classification of the user query to determine problem faced by the user based on the contextually relevant keywords. Text analysis also includes ignoring stop words in the user query to determine the problem faced by the user. Examples of stop words include, but are not limited to the, is, at, which, and on.

The natural language processing and the text analysis are performed to derive contextually relevant keywords from the user query. In other words, the keywords extracted are such that when these keywords are read in conjunction, they form a relevant context. For example, when the user query is: “I didn't get my Camera delivered still. The product ordered two weeks before.” The contextually relevant keywords that are derived are: Camera, delivered, didn't get, two weeks. These keywords when read in conjunction set a context that a camera didn't get delivered since two weeks.

While deriving these contextually relevant keywords, stops words in the user query of this example, i.e., “I,” “my,” and “still,” are ignored. Moreover, because of the iterative classification, the text analysis algorithm learns to ignore descriptive words, when one of the examples of that descriptive word is also used in the user query. For example, the word “product” is a descriptive word in the context of the user query of this example. The word “camera,” which is a product is an example of the descriptive word “product” in the context of the user query of this example. Therefore, in this case, the text analysis algorithm along with the natural language processing is used to point the term “product” to “camera.”

After the contextually relevant keywords are derived, the risk analyzing device, at 306, categorizes the contextually relevant keywords into a risk category selected from a plurality of risk categories. A set of objects are clustered into a risk category in such a way that objects in the same risk category are more similar to each other than to those in other risk categories. Categorizing includes finding a structure in a collection of unlabeled data. Each keyword is mapped into each of the plurality of risk categories based on the attributes and the properties of keywords and the risk categories. Further, similarity algorithms are used to calculate distance in order to check which keywords will be fit under each of the plurality of risk categories.

In an embodiment, in a product manufacturing supply chain network, supply chain risks may be categorized under three risk categories, i.e., an external to supply chain risk category, an internal to supply chain risk category, and a management related risk category. Each of these risk categories may be formed by grouping components associated with the product manufacturing supply chain network. This is depicted in Table 1.

TABLE 1

| Risk Category | Components |
|---|---|
| External to supply chain | Finance, Environment |
| Internal to supply chain | Process, Storage, Information |
| Management Related | Supplier, Demand, Transportation |

When the contextually relevant keywords are derived, the risk analyzing device maps these keywords to the plurality of risk categories based on the attributes of these risk categories. In continuation of the example given above, one of the keywords in the contextually relevant keywords is: “delivery.” This maps to the “Management Related risk category,” as delivery is not a part of the supply chain, either external or internal. When the contextually relevant keywords are grouped into one of the risk categories, that risk category and the associated components in the supply chain network are the only ones to be focused on. As a result time to perform the analysis is reduced, as other risk categories can be ignored and no analysis is required to be performed for these risk categories and the associated components.

After the risk category in which the contextually relevant keywords are categorized has been identified, the risk analyzing device, at 308, identifies a risk in the supply chain network based on the contextually relevant keywords and the risk category.

In continuation of the example given above, the risk category is: “Management Related;” the associated components are: “Supplier,” “Demand,” and “Transportation,” and the contextually relevant keywords are: “Camera,” “delivered,” “didn't get,” “two weeks.” To identify the risk, the risk analyszing device extracts the relations between the contextually relevant keywords based on the natural language processing performed at 304. In continuation of the example above, the basic dependencies of the contextually relevant keywords may be depicted as given below:
Camera→Delivery
didn't get→not get→delivery
delivery→two weeks

As a result, “Delivery” is mapped with some relationships and the supply chain risk is identified as: “Delivery Issue.”

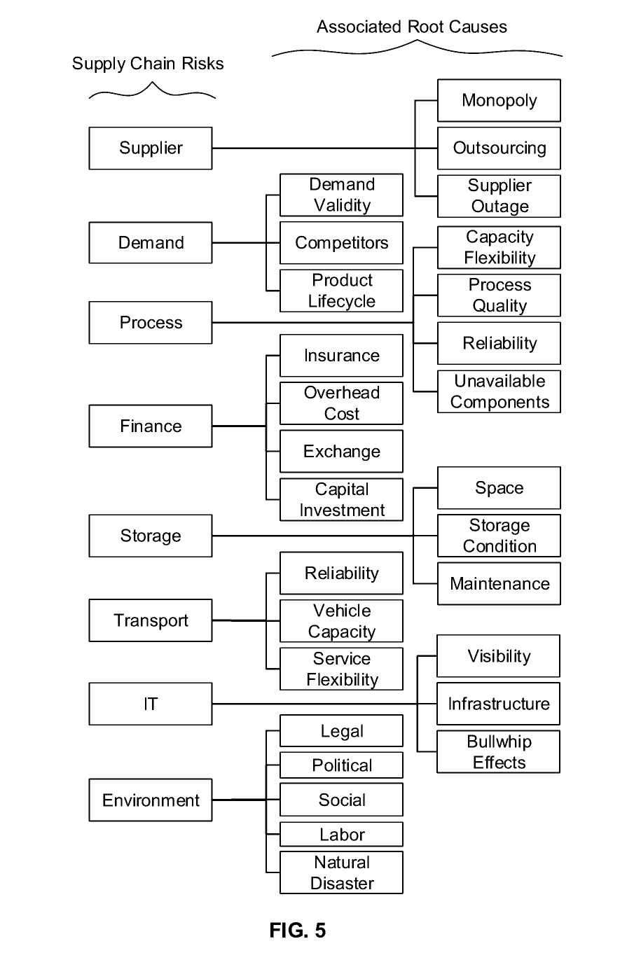

Thereafter, at 310, the risk analyzing device detects a root cause from amongst a plurality of root causes associated with the risk using a causal analysis algorithm. Each risk has an associated set of root causes. For example, for a product manufacturing supply chain network, for the risk due to the “Supplier” component, associated root causes may be one of monopoly, outsourcing, or supplier outage. Similar risk components and associated root causes for a product manufacturing supply chain network are depicted in FIG. 5. It will be apparent to a person skilled in the art that such mapping between risk components and associated root causes may be created for any type of supply chain network. In an embodiment, brainstorming and Pareto analysis may be used to derive the risk components and the associated root causes.

In continuation of the example given above, the risk is identified as “Delivery Issue” and the risk category to which the contextually relevant keywords are mapped is “Management Related.” Based on the identified risk and the attributes of the risk category, it is determined that the risk is mainly due to Transportation component of the supply chain network. Further, the root causes associated with the risk in Transportation component include: “Reliability,” “Vehicle Capacity,” and “Service Flexibility.”

To identify the top root cause amongst the plurality of root causes associated with the risk, the risk analyzing device first uses historic data that has been utilized by an intelligence learning algorithm to automatically identify association rules. Thereafter, the risk analyzing device uses a causal analysis algorithm. To this end, for each leaf node in the hierarchy of supply chain risks, the risk detection device uses the intelligence learning algorithm to repeatedly learn and ask the question “why this happened” iteratively. Based on this, the risk analyzing device identifies the main root cause for the risk. In continuation of the example given above, “Transportation” is identified as the risk component in the product manufacturing supply chain network. By using the causal analysis algorithm, the risk analyzing device establishes that most of the Transportation problems will be under “Delivery Reliability.” Therefore, by eradicating or remove the causes for the transportation problems or disruptions, the product manufacturing supply chain network may become profitable. The above discussed exemplary causal analysis, which includes causes and effects for this scenario, is depicted through the fishbone diagram given below:

The proposed method identifies the supply chain risk by its own intelligence from the user query and diagnoses the root cause of the supply chain risk. Therefore, helps in improving profitability of the supply chain network. This method is a great time saving approach as it reduces manual efforts in tracking the customer ticket logs. The system is also an incremental learning system that meets customer satisfaction in a shorter turnaround time.

FIG. 4 illustrates a flowchart of a method of identifying root causes in a supply chain network, in accordance with another embodiment. At 402, a risk analyzing device receives a plurality of supply chain inputs associated with the supply chain network. The plurality of supply chain inputs may include, but are not limited to supply chain contributors, supply chain parameters, and supply chain data sources. The supply chain contributors may include but are not limited to raw material suppliers, manufacturers, whole-salers, retailers, distributors, and the customers. Customers may vary depending upon the type of supply chain network. Further, the supply chain parameters include, but are not limited to supply, demand, transportation, process, storage, information, finance, and environment. The supply chain data sources are selected based on the supply chain parameters.

Thereafter, at 404, the risk analyzing device receives a user query. The risk analyzing device performs natural language processing and text analysis on the user query, at 406. To this end, at 406a, the risk analyzing device ignores stop words in the user input to derive contextually relevant keywords. The risk analyzing device then iteratively classifies the user input to determine problem faced by the user based on the contextually relevant keywords at 406b. This has been explained in conjunction with FIG. 3.

At 408, the risk analyzing device categorizes the contextually relevant keywords into a risk category selected from a plurality of risk categories. Thereafter, at 410, the risk analyzing device identifies a risk in the supply chain network based on the contextually relevant keywords and the risk category. At 412, the risk analyzing device detects a root cause from amongst a plurality of root causes associated with the risk using a causal analysis algorithm. This has been explained in detail in conjunction with FIG. 3.

At 414, the risk analyzing device implements incremental intelligence using machine learning techniques for future data analysis. The risk analyzing device uses machine learning techniques to monitor the entire system and to learn user's behavior. The risk identification system captures all user queries that are received and creates a mapping of these user queries with the identified risks and subsequently identified root causes. This enables incremental learning for the risk analyzing device. As a result, for future queries entered by the user, a root cause can be determined promptly using the incremental learning and stored data. For example, if a user query is similar to the previously stored data, the risk detection device will directly provide the solution using the incremental learning without any processing. As a result, the problem faced by the user can be resolved promptly, thereby, improving user experience and increasing efficiency of the supply chain network.

Various embodiments of the technology provide methods and system for identifying risks and associated root causes in supply chain networks. The proposed method identifies the supply chain risk by its own intelligence from the user query and diagnoses the root cause of the supply chain risk. Therefore, helps in improving profitability of the supply chain network. This method is a great time saving approach as it reduces manual efforts in tracking the customer ticket logs. The system is also an incremental learning system that meets customer satisfaction in a shorter turnaround time.

The specification has described methods and systems for identifying risks and associated root causes in supply chain networks. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of identifying root causes in supply chain networks, the method comprising:
receiving, by a risk analyzing device, a user query;
performing, by the risk analyzing device, natural language processing and text analysis on the user query to derive one or more contextually relevant keywords from the user query;
categorizing, by the risk analyzing device, the contextually relevant keywords into at least one of a plurality of risk categories;
identifying, by the risk analyzing device, a risk in a supply chain network based on the contextually relevant keywords and the at least one of the plurality of risk categories; and
detecting, by the risk analyzing device, a root cause associated with the risk using a causal analysis.

2. The method of claim 1, wherein the user query comprises an audio query or a text query.

3. The method of claim 1 further comprising receiving, by the risk analyzing device, a plurality of supply chain inputs associated with the supply chain network, wherein at least one of:
the plurality of supply chain inputs comprise one or more supply chain contributors, supply chain parameters, or supply chain data sources, the supply chain data sources selected based on the supply chain parameters; or
the supply chain parameters comprise one or more supply, demand, transportation, process, storage, information, finance, or environment parameters.

4. The method of claim 1, wherein performing the text analysis further comprises at least one of:
iteratively classifying the user input to determine a problem faced by the user based on the contextually relevant keywords; or
ignoring one or more stop words in the user query.

5. The method of claim 1, wherein the plurality of risk categories comprise an external to supply chain category, an internal to supply chain category, or a management-related category.

6. The method of claim 1, further comprising implementing, by the risk analyzing device, incremental intelligence using one or more machine learning techniques for future data analysis.

7. A risk analyzing device comprising one or more processors and a memory coupled to the one or more processors which are configured to execute one or more programmed instructions comprising and stored in the memory to:
receive a user query;
perform natural language processing and text analysis on the user query to derive one or more contextually relevant keywords from the user query;
categorize the contextually relevant keywords into at least one of a plurality of risk categories;
identify a risk in a supply chain network based on the contextually relevant keywords and the at least one of the plurality of risk categories; and
detect a root cause associated with the risk using a causal analysis.

8. The risk analyzing device as set forth in claim 7, wherein the user query comprises an audio query or a text query.

9. The risk analyzing device as claimed in claim 7, wherein the one or more processors are further configured to execute one or more additional programmed instructions comprising and stored in the memory to receive a plurality of supply chain inputs associated with the supply chain network, wherein at least one of:
the plurality of supply chain inputs comprise one or more supply chain contributors, supply chain parameters, or supply chain data sources, the supply chain data sources selected based on the supply chain parameters; or
the supply chain parameters comprise one or more supply, demand, transportation, process, storage, information, finance, or environment parameters.

10. The risk analyzing device as claimed in claim 7, wherein the one or more processors are further configured to execute one or more additional programmed instructions comprising and stored in the memory to at least one of:
iteratively classify the user input to determine a problem faced by the user based on the contextually relevant keywords; or
ignore one or more stop words in the user query.

11. The risk analyzing device as claimed in claim 7, wherein the plurality of risk categories comprise an external to supply chain category, an internal to supply chain category, or a management-related category.

12. The risk analyzing device as claimed in claim 7, wherein the one or more processors are further configured to execute one or more additional programmed instructions comprising and stored in the memory to implement incremental intelligence using one or more machine learning techniques for future data analysis.

13. A non-transitory computer readable medium comprising instructions stored thereon for identifying root causes in supply chain networks, which when executed by one or more processors, cause the one or more processors to perform steps comprising:
receiving a user query;
performing natural language processing and text analysis on the user query to derive one or more contextually relevant keywords from the user query;
categorizing the contextually relevant keywords into at least one of a plurality of risk categories;
identifying a risk in a supply chain network based on the contextually relevant keywords and the at least one of the plurality of risk categories; and
detecting a root cause associated with the risk using a causal analysis.

14. The non-transitory computer readable medium as claimed in claim 13, wherein the user query comprises an audio query or a text query.

15. The non-transitory computer readable medium as claimed in claim 13, further comprising one or more additional programmed instructions, which when executed by the one or more processors, further cause the one or more processors to perform one or more additional steps comprising receiving a plurality of supply chain inputs associated with the supply chain network, wherein at least one of:
the plurality of supply chain inputs comprise one or more supply chain contributors, supply chain parameters, or supply chain data sources, the supply chain data sources selected based on the supply chain parameters; or
the supply chain parameters comprise one or more supply, demand, transportation, process, storage, information, finance, or environment parameters.

16. The non-transitory computer readable medium as claimed in claim 13, further comprising one or more additional programmed instructions, which when executed by the one or more processors, further cause the one or more processors to perform one or more additional steps comprising at least one of:
iteratively classifying the user input to determine a problem faced by the user based on the contextually relevant keywords; or
ignoring one or more stop words in the user query.

17. The non-transitory computer readable medium as claimed in claim 13, wherein the plurality of risk categories comprise an external to supply chain category, an internal to supply chain category, or a management-related category.

18. The non-transitory computer readable medium as claimed in claim 13, further comprising one or more additional programmed instructions, which when executed by the one or more processors, further cause the one or more processors to perform one or more additional steps comprising implementing incremental intelligence using one or more machine learning techniques for future data analysis.
